(19) United States
(12) Patent Application Publication
(10) Pub. No.: US 2026/0288332 A1
(43) Pub. Date: Sep. 24, 2026

(54) METHOD AND SYSTEM WITH PARALLEL BLOCK DECOMPRESSION

(71) Applicant: Samsung Electronics Co., Ltd., Suwon-si (KR)

(72) Inventors: Madhur JUNEJA, Bengaluru (IN); Arnab ROY, Bengaluru (IN); Kiran Kolar CHANDRASEKHARAN, Bengaluru (IN); Nilay Nitin BIRMOLE, Bengaluru (IN); Nihar Venkata Raj BURADA, Bengaluru (IN); Jihoon NAM, Suwon-si (KR)

(73) Assignee: Samsung Electronics Co., Ltd., Suwon-si (KR)

(21) Appl. No.: 19/564,894

(22) Filed: Mar. 12, 2026

(30) Foreign Application Priority Data
Mar. 21, 2025 (IN) 202541025856
Jun. 5, 2025 (KR) 10-2025-0074011

(51) Int. Cl. G06F 3/06

(52) U.S. Cl. CPC G06F 3/0608; G06F 3/064; G06F 3/0679

(57) ABSTRACT

A method and system for optimized data decompression using parallel block processing are provided. A method of performing data decompression includes: receiving compressed input data including blocks; based on the compressed input data, for each of the blocks, determining a corresponding literal length and a corresponding match length; determining first blocks, each of whose literal length and match length are each less than a threshold; identifying consecutive independent blocks from among the first blocks; and decompressing the compressed input data by parallelly processing, with respect to each other, each of the consecutive input blocks.

### CROSS-REFERENCE TO RELATED APPLICATIONS

This application claims the benefit under 35 USC § 119(a) of Indian Patent Application number 202541025856, filed on Mar. 21, 2025, in the Indian Patent Office, and Korean Patent Application No. 10-2025-0074011, filed on Jun. 5, 2025, in the Korean Intellectual Property Office, the entire disclosures of which are incorporated by reference herein for all purposes.

### BACKGROUND

### 1. Field

The following description relates to the field of data decompression. More particularly, the description herein relates to optimized decompression using parallel block processing.

### 2. Description of Related Art

Modern high-performance computing demands higher memory capacity and higher memory bandwidth, with a focus on computational efficiency. Transfer of data to/from memory is often the limiting factor of computation, particularly for artificial intelligence computing. To relieve the pressure on memory devices, compression techniques are commonly applied to improve capacity and bandwidth. Naturally, compressed data must be decompressed to produce desired outputs.

Since decompression is part of a read path of a memory device (e.g., at any of various layers of the storage stack), a fast decompression speed is desirable, which can be challenging when implementing data compression in hardware. Decompression speed has a significant impact on the access time (latency) of the memory device, and thus on the overall performance of a system using the memory device. Furthermore, efficient compression techniques generally provide a balance between compression ratio and decompression speed.

To better understand challenges associated with decompression techniques, consider some data compression techniques. Many existing compression algorithms are difficult to implement in hardware accelerators due to high decompression latency. One such technique is the Lempel-Ziv 4 (LZ4) compression technique. Another compression algorithm is a history-based or search-based algorithm; a variation of the LZ77 technique. Particularly, a history/search-based compression algorithm may identify patterns based on previously processed data. Instead of duplicating characters/literals in an identified pattern, corresponding pattern information (e.g., a position, initial point, and length of a pattern) may be stored as compressed data. Accordingly, the LZ4 compression algorithm may encode matching patterns in an already scanned string (i.e., history) into information such as a pattern start index and a pattern size and store the encoded patterns (codes representing the patterns) instead of copying the entire pattern string. However, the process of decompressing such compressed data is hardware-intensive

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing data decompression includes: receiving compressed input data including blocks; based on the compressed input data, for each of the blocks, determining a corresponding literal length and a corresponding match length; determining first blocks, each of whose literal length and match length are each less than a threshold; identifying consecutive independent blocks from among the first blocks; and decompressing the compressed input data by parallelly processing, with respect to each other, each of the consecutive input blocks.

The decompressing of the compressed input data may include: concatenating the parallelly processed consecutive input blocks; and updating the concatenated parallelly processed consecutive input blocks in a search history buffer.

The identifying of the consecutive input blocks among the first blocks may include: in a search history buffer, comparing positions of matched strings of the respective first blocks with positions of outputs of each of previous blocks among the first blocks; and based on a result of the comparison, in response to a position of a matched string of a first block of the first blocks failing to overlap with the position of the output of each of the previous blocks, determining the consecutive input blocks.

The method may further include: identifying second blocks, each of whose literal length and match length are both greater than or equal to the threshold.

The method may further include: sequentially processing each of the identified second blocks.

The method may further include: simultaneously updating the processed second blocks in a search history buffer.

The sequential processing of each of the identified second blocks may be performed after parallelly processing each of the consecutive input blocks.

The sequential processing of each of the identified second blocks may be performed before parallelly processing each of the consecutive input blocks.

Each of the blocks may include: a token having a size of at least 1 byte and including a first set of bits corresponding to the block's literal length and a second set of bits corresponding to the block's match length; pieces of literal data associated with a mismatched string; and a match offset having a size of at least 2 bytes and indicating an initial point of a matched string associated with each of blocks in a search history buffer, wherein the literal length may indicate a length of a corresponding mismatched string, and the match length may indicate a length of a corresponding matched string from an initial point of the corresponding matched string.

A non-transitory computer-readable storage medium may store instructions that, when executed by a processor, cause the processor to perform any of the methods.

In another general aspect, a system for performing data decompression includes: a processor including processor circuitry, memory storing instructions or code that when executed by the processor cause the system to: receive compressed input data including blocks; based on the compressed input data, determine, for each of the blocks, a corresponding literal length and a corresponding match length; determine first blocks, each of whose literal length and the match length are each less than a threshold; identify consecutive independent blocks among the first blocks; and decompress the compressed input data by parallelly processing, with respect to each other, each of the consecutive input blocks using parallel decompression.

The parallel decompression may decompress the compressed input data by: concatenating the parallelly processed consecutive input blocks; and in a search history buffer, simultaneously updating the concatenated parallelly processed consecutive input blocks.

The instructions or code may further cause the system to, in order to identify the consecutive input blocks among the first blocks: in a search history buffer, compare positions of matched strings of the respective first blocks with position of outputs of each of previous blocks among the first blocks; and based on a result of the comparison, in response to a position of a matched string of a first block among the first blocks failing to overlap with the position of the output of each of the previous blocks, determine the consecutive input blocks.

The instructions or code may further cause the system to identify second blocks, each of whose literal length and match length are both greater than or equal to the threshold.

The decompression module may be configured to sequentially process each of the identified second blocks.

The decompression module may be configured to simultaneously update the processed second blocks in a search history buffer.

The instructions or code further cause the system to sequentially process each of the identified second blocks after parallelly processing each of the consecutive input blocks.

The instructions or code further cause the system to: sequentially process each of the identified second blocks before parallelly processing each of the SIB.

Each of the blocks may include: a token having a size of at least 1 byte and including a first set of bits corresponding to the literal length and a second set of bits corresponding to the match length; pieces of literal data associated with a mismatched string; and a match offset having a size of at least 2 bytes and indicating an initial point of a matched string associated with each of blocks in a search history buffer, the literal length indicates a length of a corresponding mismatched string, and the match length indicates a length of a corresponding matched string from an initial point of the corresponding matched string.

In another general aspect, an electronic device includes: a memory storing instructions; and processors communicatively connected with the memory, wherein the instructions, when executed by the processors individually or collectively, cause the electronic device to: receive compressed input data including a plurality of blocks; based on the compressed input data, determine a literal length and a match length associated with each of the plurality of blocks; determine a first set of blocks first blocks in which each of the literal length and the match length is less than a set threshold value; identify consecutive independent blocks consecutive input blocks among the first blocks; and decompress the compressed input data by parallelly processing, with respect to each other, each of the consecutive input blocks.

Other features and aspects will be apparent from the following detailed description, the drawings, and the claims.

### BRIEF DESCRIPTION OF THE DRAWINGS

In the drawings and the related description, the same or similar reference numerals may be used to designate the same or similar elements.

FIG. 1A illustrates an example of a history-based compression algorithm according to related art.

FIG. 1B illustrates an example of a Lempel-Ziv 4 (LZ4) compression algorithm, according to related art.

FIG. 2A illustrates of details of example blocks generated by an LZ4 compression algorithm, according to related art.

FIG. 2B illustrates an example of a literal length included in a block generated by the LZ4 compression algorithm, according to related art.

FIG. 2C illustrates an example of a match length included in a block generated by the LZ4 compression algorithm, according to related art.

FIG. 3A illustrates an example of information included in a block used for decompression, according to related art.

FIG. 3B illustrates an example in which compressed data of an input buffer is decompressed and updated in an output buffer (OB), according to related art.

FIG. 3C illustrates an example of extracting a matched string from a search history buffer (SHB) and decompressing the matched string, based on a match offset and a match length, according to related art.

FIG. 4 illustrates an example in which a position of a matched string of a block overlaps with a position of an output of a previous block in a search history during a process of decompressing multiple blocks, according to related art.

FIG. 5 illustrates an example of an optimized data decompression system for decompressing blocks in parallel, according to embodiments.

FIG. 6A illustrates an example of a first block during an optimized data decompression process.

FIG. 6B illustrates an example of a second block during the optimized data decompression process, according to embodiments.

FIG. 7 illustrates an example of a consecutive independent block identified during an optimized data decompression process, according to embodiments.

FIG. 8A illustrates an example of a parallel decompression module (PDM), according to embodiments.

FIG. 8B illustrates a detailed example of the PDM, according to embodiments.

FIG. 9 illustrates an example of an optimized data decompression method using parallel block processing, according to embodiments.

FIG. 10 illustrates an example of a configuration of an electronic device for decompressing data, according to embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Described herein are systems and methods for reducing compression latency using a parallel block decompression algorithm for data compressed by a Lempel-Ziv 4 (LZ4) compression algorithm. The systems and methods may reduce overall decompression latency by processing compressed data of multiple independent small blocks in parallel.

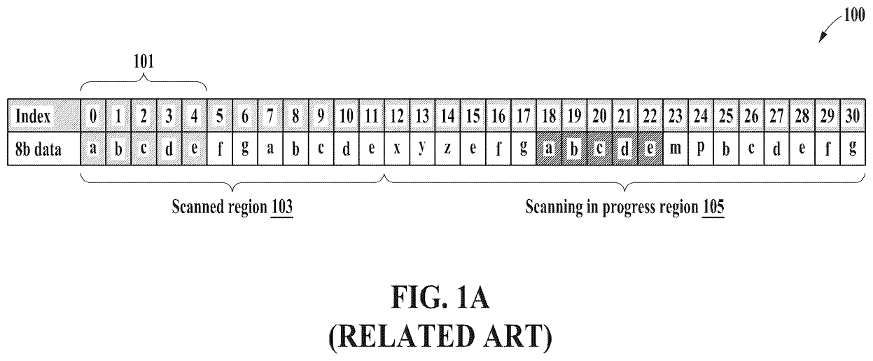

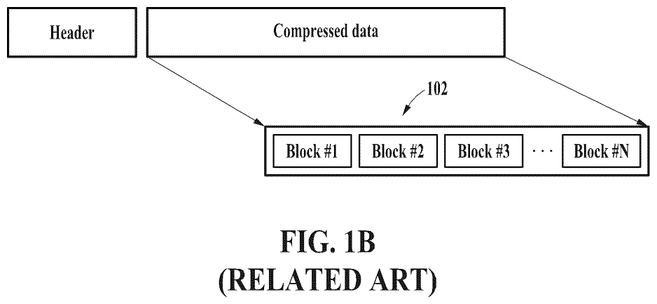

FIG. 1A illustrates an example of a history-based compression algorithm according to related art.

Referring to FIG. 1A, a string 100 may include 8-bit characters, for example. The string 100 may be divided into two regions; a scanned region 103 in which scanning has finished and a scanning-in-progress region 105. The scanned region 103 may function as a history used to identify patterns. For example, during data scanning, a potential pattern 101 such as “abcde” 101 may be found in the scanned region 103. In this example, “abcde” is a matched pattern or a matched string. The matched string is found at position 0, and the size (or pattern length) of the matched string is 5. Therefore, instead of copying “abcde” for the compressing, the matched string may be encoded into a tuple (e.g. {loc=0, size=5}) and the encoded corresponding matched information may be stored as compressed data. The rest of the data before the matched pattern may be considered to be a mismatched (unmatched) string and is therefore copied verbatim into the compressed data (e.g., “fg” in FIG. 1). After the matched string and the mismatched string are processed (that is, corresponding information is stored in the compressed data), the corresponding data in the scanning-in-progress region 105 may be added to the scanned region 103. Through this process, the number of bits required for encoding the original data may be reduced.

FIG. 1B illustrates an example of an LZ4 compression algorithm, according to related art.

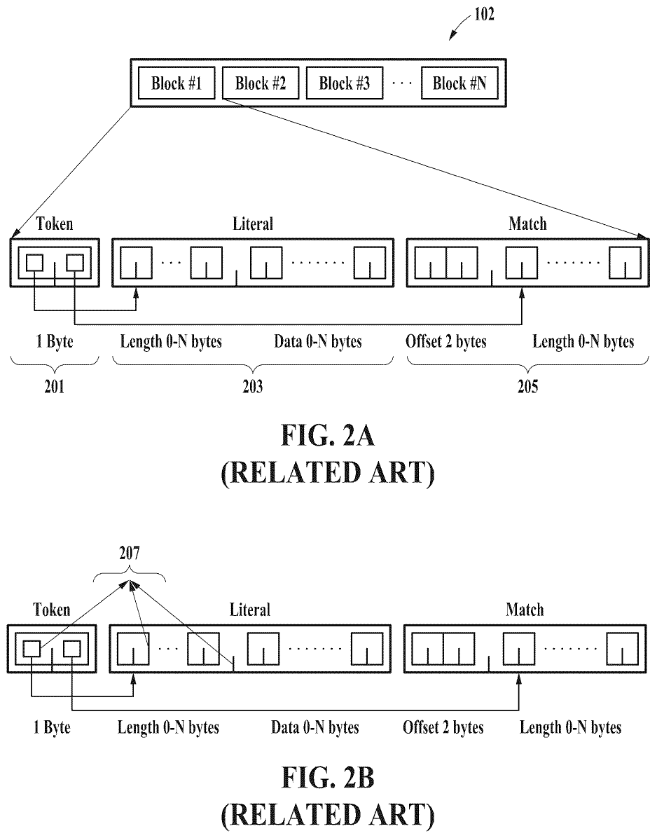

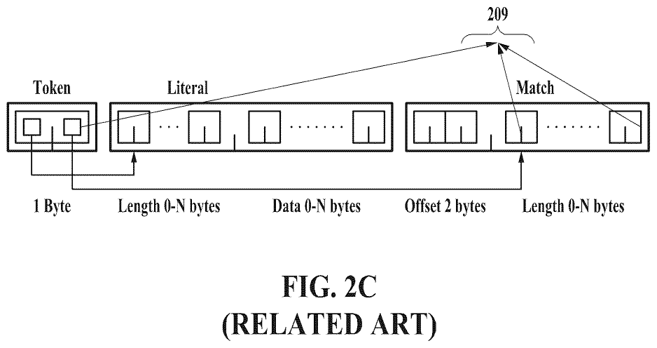

Referring to FIG. 1B, the LZ4 compression algorithm generates and chains blocks 102 to compress original data. Each of the blocks 102 may be configured/formatted to balance the number of bits encoding a matched string and a mismatched string. Each block may have a variable size and may include information about its matched string and its mismatched string. Additionally, each block may have a header that stores data/information related to original data compression. Configurations of the blocks 102 are described with reference to FIGS. 2A to 2C.

FIGS. 2A to 2C illustrate examples of a detailed configuration of each block generated by an LZ4 compression algorithm, according to a related art.

Referring to FIG. 2A, the LZ4 compression algorithm generates the blocks 102 (e.g., Block #1 to Block #N) to compress original data. Each block stores information about a matched string and a mismatched string. As shown in FIG. 2A, each block may include three sections; a token section 201, a literal section 203, and a match section 205.

The token section 201 includes information about the length of the literal portion of the block (TOKEN[7:4] or TOKEN.L) and includes information about the length of the match portion of the block (TOKEN[3:0] or TOKEN.M).

The literal section 203 may have a size of 0 to N bytes and in some cases may store additional information about the literal length and literal data.

The match section 205 may have a size of 2 to N bytes and may store additional information about the match length and an offset within a search history (the scanned region 103) in which a match is identified.

FIG. 2B illustrates an example of a literal length included in a block generated by the LZ4 compression algorithm, according to a related art.

Referring to FIG. 2B, the LZ4 compression algorithm may calculate a total literal length (lit_length) 207 from the corresponding 4 bits (TOKEN[7:4]) of the token section 201 (mandatory). Additionally, the LZ4 compression algorithm may also determine the total literal length 207 by adding length information of the literal section 203 (optional). The calculation method is as follows:

If Token[7:4]<0XF: lit_length=Token[7:4] (LITERAL.Length bytes are absent)

$$Else : lit\_length = Token [ 7 : 4 ] + {Σ}_{i = 0}^{N - 1} Literal . Length [ i ] .$$

Here, the Literal. Length byte is valid until a non-0xFF value is found, and Literal. Length[N−1]≠0xFF; i.e., the non-00xF.

The LZ4 compression algorithm may scan the Literal. Length byte and then copy lit_length of mismatched literals/characters into a block (e.g. Block #1).

FIG. 2C illustrates an example of a match length included in a block generated by the LZ4 compression algorithm, according to a related art.

Referring to FIG. 2C, for the match section 205 (as illustrated in FIG. 2A), the match length 209 may be determined according to a threshold for the match length 209. According to related art, the threshold may be m, and m may be any number. In addition, the threshold m may help to identify a matched pattern. Accordingly, the match section 205 may be formed only when the minimum match length (threshold) m is found. The LZ4 compression algorithm may use an offset of 2 bytes or 16 bits as a match offset size to indicate a match position, and an offset of 16 bits may indicate that the maximum input string size is 2¹⁶=64 kilobytes (KB). In addition, the match length (match_length) 209 may be calculated from 4 bits (TOKEN[3:0]) (mandatory) of the token section 201 and a length portion of the match section 205 (optional) as follows:

If Token[3:0]<0XF: match_length=Token[3:0] (MATCH.Length bytes are absent)

$$Else : match\_length = Token [ 3 : 0 ] + {Σ}_{i = 0}^{N - 1} MATCH . Length [ i ] + m ( match threshold ) .$$

Here, a MATCH.Length byte may be valid until a non-0xFF byte is found, and MATCH.Length[N−1]≠0xFF.

A decompression algorithm for each block is described next.

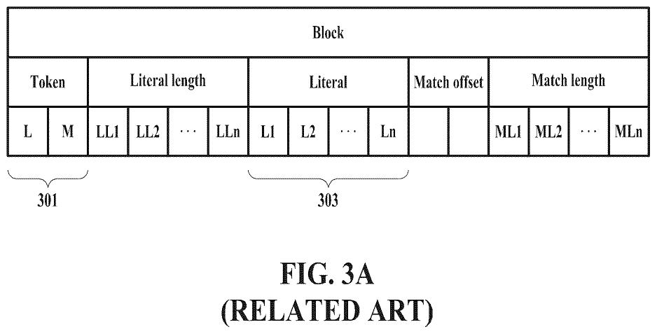

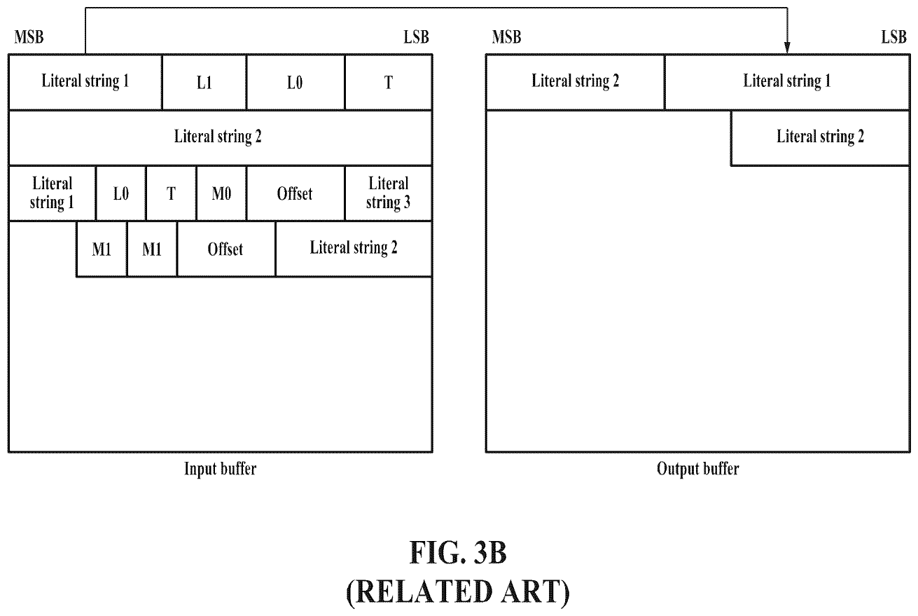

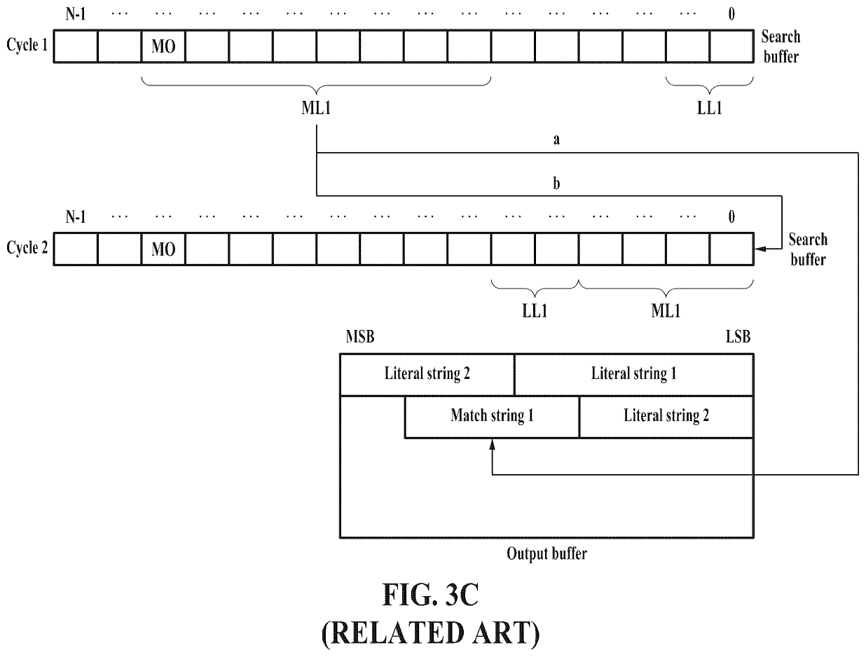

FIGS. 3A, 3B, and 3C illustrate examples of decompression of blocks, according to related art.

FIG. 3A illustrates an example of information included in a block used for decompression, according to related art.

FIG. 3B illustrates an example in which compressed data of an input buffer is decompressed and updated in an output buffer (OB), according to related art.

FIG. 3C illustrates an example of extracting a matched string from a search history buffer (SHB) and decompressing the matched string, based on a match offset and a match length, according to related art.

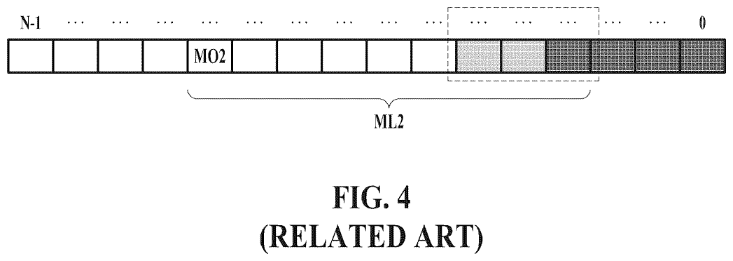

FIG. 4 illustrates an example in which a position of a matched string of a block overlaps with a position of an output of a previous block in a search history during a process of decompressing blocks, according to related art.

Referring to FIGS. 3A and 3B, each block may include a token 301, a literal length, a literal 303, a match offset, and a match length. Initially, a decompression algorithm may extract the token 301 from each block. Then, for a given block, the decompression algorithm may determine the literal length and the match length of its token 301. Furthermore, the decompression algorithm may determine the literal length of each block.

In addition, the decompression algorithm may calculate a total literal length of a given block by summing the literal length of the given block's token 301 and the remaining literal length of the literal section 203 of each block. Thereafter, the decompression algorithm may extract the literal 303 based on the total literal length. In addition, based on the total literal length, the decompression algorithm may decompress a mismatched string of each block and update the decompressed mismatched string in an OB. In this case, the decompression algorithm may update the decompressed mismatched string in the OB from the least significant byte to the most significant byte (in a direction from right to left).

Furthermore, referring to FIG. 3C, based on a match offset and a match length ML1, the decompression algorithm may extract a matched string from an SHB and decompress the matched string. Here, ML1 may be the sum of the match length, the remaining match length, and the match threshold of the token 301. The decompressed matched string may be added to the OB. As a result, the matched string of each block may be decompressed. In addition, the decompression algorithm may simultaneously update the decompressed mismatched string and the matched string in the SHB. The update may proceed from the right side to the left side. Therefore, stages a and b may be performed in parallel.

Additionally, there is a possibility that the literal length and/or the match length may increase, which may result in increased decompression cycles for at least one of the blocks being decompressed. The decompression cycles may increase because multiple cycles are used to transfer each literal byte from an input buffer to an OB or to transfer a match byte from an SHB to the OB.

The decompression algorithm described above has limitations. For instance, there is a possibility that the number of bytes of a literal length and the number of bytes of a match length may be different from block to block, which often causes the timing of the decompression cycle for each block to vary from block to block. As a result, the timing difference of the decompression cycles may cause decompression latency for each block, which makes parallel processing of blocks less efficient; data that in theory could be being decompressed in parallel is not.

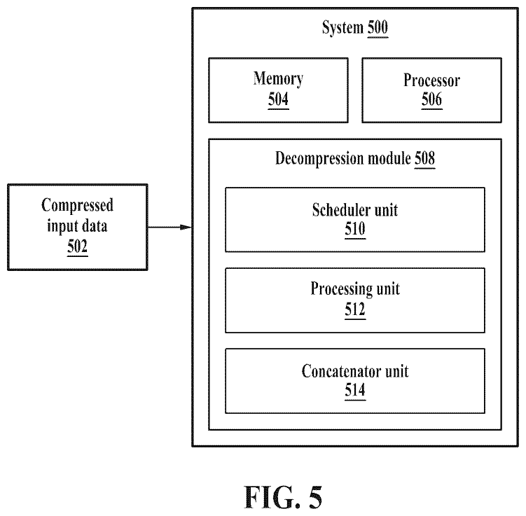

To solve this decompression latency issue, each block may be decompressed by a parallel block decompression algorithm. However, as shown in FIG. 4, there is a possibility that the position of the matching string of a predetermined block may overlap with the position of an output of previous blocks, which are being processed together. Such kind of blocks may be referred to as dependent blocks. Decompression may be performed in in parallel by considering the dependent blocks, as described with reference to FIGS. 5 to 8B.

FIG. 5 illustrates an example of an optimized data decompression system 500 for decompressing blocks in parallel, according to embodiments.

Referring to FIG. 5, the system 500 may receive compressed input data (CID) 502 from an input buffer, identify small and large blocks therein, and process the small and large blocks accordingly, as described below. The system 500 is configured to efficiently provide decompression data associated with the CID 502.

The system 500 may include a memory 504, a processor 506, and a decompression module (DM) 508. The memory 504 and the DM 508 may be connected with the processor 506. In this example, the DM 508 may be an LZ4 decompression module. In another example, the system 500 may be comprised in an electronic device, such as a mobile device or a laptop computer, capable of compressing data.

The memory 504 may be a non-volatile, non-transitory computer-readable medium known in the art including a volatile memory, such as static random-access memory (SRAM) and dynamic RAM (DRAM), and/or a non-volatile memory, such as read-only memory (ROM), erasable programmable ROM (EPROM), flash memory, a hard disk, an optical disk, or magnetic tape, as non-limiting examples. The memory 504 may include data used by at least one component of the system 500. For example, the data may be data of software input/output for a command related thereto. A memory 130 may include a volatile memory and/or a non-volatile memory.

In addition, the memory 504 may include an operating system (OS) for performing tasks of the system 500. Furthermore, the memory 504 may store CID that is to be decompressed.

The processor 506 may include a single processing device or multiple devices, each of which may include operation units. The processor 506 may be implemented as microprocessors, microcomputers, microcontrollers, digital signal processors, central processing units (CPUs), state machines, logic circuits, and/or devices that manipulate signals according to operation instructions (e.g., digital signal processors). The processor 506 may perform a variety of functions including retrieving and executing computer-readable instructions/code and data stored in the memory 504.

The DM 508 decompresses the CID 502 received from the memory 504. The DM 508 may be configured to determine/identify a first blocks (“small blocks”). The DM 508 may be configured to then identify consecutive independent blocks (CIBs) of the first blocks. Additionally, the DM 508 may be configured to decompress the received CID 502 by simultaneously processing the identified CIBs. For that purpose, the DM 508 may include a scheduler unit (SU) 510, a PU 512, and a concatenator unit (CU) 514.

The SU 510 may be configured to determine/identify first blocks and to identify (e.g., based on string lengths of the first blocks) CIBs among the first blocks. Then, the SU 510 may transfer the identified CIBs to the PU 512 for parallel decompression.

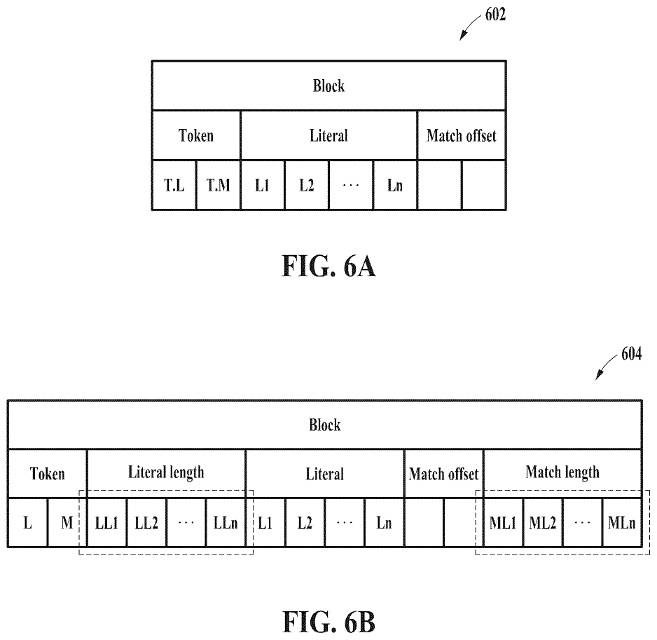

Additionally, the PU 512 may be configured to decompress the received CID 502 together with a parallel decompression module (PDM) 802 for optimized data decompression. The optimized data decompression is described with reference to FIGS. 6A to 8B.

The processor 506 may be configured to perform optimized data decompression by decompressing the CID 502 received from the memory 504. Additionally, the processor 506 may be configured to perform the operations described with reference to FIGS. 6A to 8B.

FIG. 6A illustrates an example first block 602 during an optimized data decompression process, according to embodiments.

FIG. 6B illustrates an example second block 604 during the optimized data decompression process, according to embodiments.

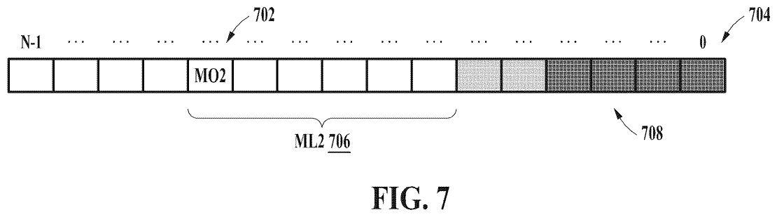

FIG. 7 illustrates an example of CIBs 702 identified during an optimized data decompression process, according to embodiments.

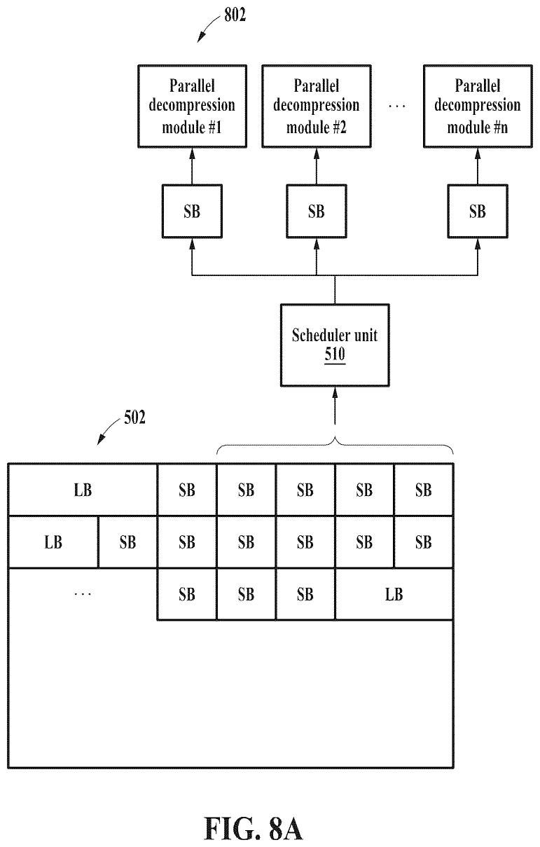

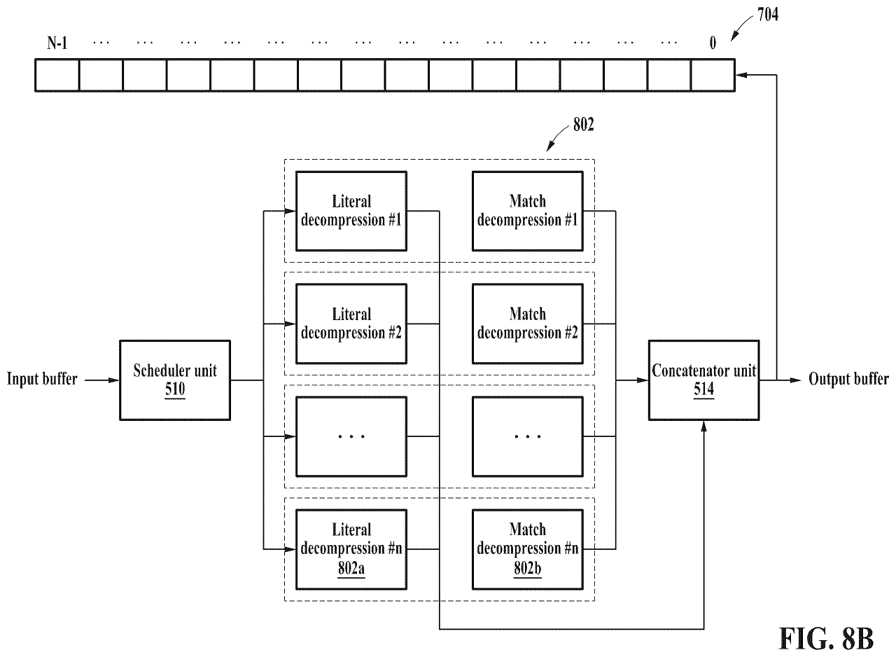

FIG. 8A illustrates an example of the PDM 802, according to embodiments.

FIG. 8B illustrates a detailed example of the PDM 802, according to embodiments.

Referring to FIG. 5, the SU 510 may be configured to receive the CID 502. The received CID 502 may include multiple compressed (e.g., LZ4) blocks. Additionally, the received CID 502 may be provided to an input buffer.

The SU 510 may be configured to determine a literal length and a match length for each block of the received CID 502, and these lengths may be used to identify and segregate small and large blocks, as described next.

As noted above, each of the compressed blocks may include a token, pieces of literal data, a match offset, a literal length, and a match length.

The token may have a minimum size of 1 byte and may include a first set of bits corresponding to the literal length and a second set of bits corresponding to the match length. Each set of bits may include 4 bits.

The pieces of literal data of a block may be associated with a mismatched (or unmatched) string of the block, and the literal length may indicate the length of the mismatched string.

The match offset may indicate an initial point of a matched string in an SHB and may have a minimum size of 2 bytes. The match length may indicate the length of the matched string from the initial point of the matched string.

The SU 510 may be configured to determine/identify the first blocks on the basis of having a literal length and a match length that are each less than a threshold; an example first block 602 is illustrated in FIG. 6A. Put another way, the first blocks may be blocks determined to include a token in which the literal length and the match length are determined to each be less than a threshold (e.g., having a value of 15).

The first blocks may also be referred to as “small blocks”. When the threshold is 15, for example, the literal lengths of the respective first blocks may be less than 15 (for example), and their respective match lengths may each be less than 15 plus a match-threshold. The match-threshold may help identify a matched pattern in each first block and is not limited to any particular value.

The functionality of identifying first blocks configured into the hardware structure may help provide fixed (or ceilinged) decoding latency in hardware for each of the first blocks. It may also facilitate design of parallel-processing hardware for parallel block decompressing.

In addition to identifying small/first blocks in the CID 502, the SU 510 may be configured to identify large (relative to the small blocks) second blocks (in the CID 502) which each have either a literal length or a match length (per their tokens) that is greater than or equal to the threshold (e.g., 15), as is the case with the example second block 604 shown in FIG. 6B.

In the large block case, when either the literal length or the match length associated with a block's token is greater than or equal to the threshold, the block may be determined to be a second block. As noted, second blocks may be also be referred to as “large blocks.” The threshold may have a value set to 15, as a non-limiting example.

Turning to the CIBs, the SU 510 may be configured to identify the CIBs in the first blocks. Example CIBs 702 are shown in FIG. 7.

Referring to FIG. 7, the SU 510 may be configured to, for each first block in an SHB 704, compare a position of a matched string 706 associated with a first block with a position of an output of previous blocks 708 among the first blocks. The output of each of the previous blocks 708 may be simultaneously updated in the SHB 704 after decompression is completed. The SU 510 may determine the CIBs based on the positional comparison. The SU 510 may determine/identify a first block as belonging to the CIBs when the position of its matched string does not overlap with the position of the output of the previous blocks.

In addition, referring to FIGS. 5, 8A, and 8B, the PU 512 may be configured to decompress the received CID 502 by simultaneously processing each block in the CIBs (as identified using the PDM 802). The PU 512 may be configured to decompress received CID by simultaneously processing the CIBs thereof using PDMs.

Each PDM 802 may include a literal DM 802a and a match DM 802b (or multiple of each), as illustrated in FIG. 8B. In addition, the PU 512 may be configured to process mismatched strings in parallel according to literal lengths of the CIBs using the literal DM 802a. In addition, the PU 512 may be configured to process matched strings in parallel and simultaneously according to matched lengths of the CIBs using the match DM 802b.

Additionally, the CU 514 may be configured to concatenate the simultaneously processed CIBs to obtain decompressed data (DD) from the received CID 502. Specifically, the CU 514 may concatenate each of the simultaneously processed matched strings and mismatched strings to obtain the DD. Thereafter, the DD may be provided to an OB. Additionally, the CU 514 may be configured to simultaneously update the CIBs processed in the SHB 704.

In addition, the PU 512 may be configured to sequentially process each of the second blocks (identified using the PDM 802) according to of the following conditions.

The PU 512 may be configured to sequentially process each of the second blocks identified using the PDM 802. In this case, the PU 512 may simultaneously process each of the CIBs using the PDM 802 to decompress the received CID 502 and then decompress each of the second blocks.

The PU 512 may be configured to sequentially process each of the second blocks identified using the PDM 802. In this case, the PU 512 may first decompress each of the second blocks before simultaneously processing each of the CIBs using the PDM 802.

The CU 514 may be configured to simultaneously update the processed second in the SHB 704.

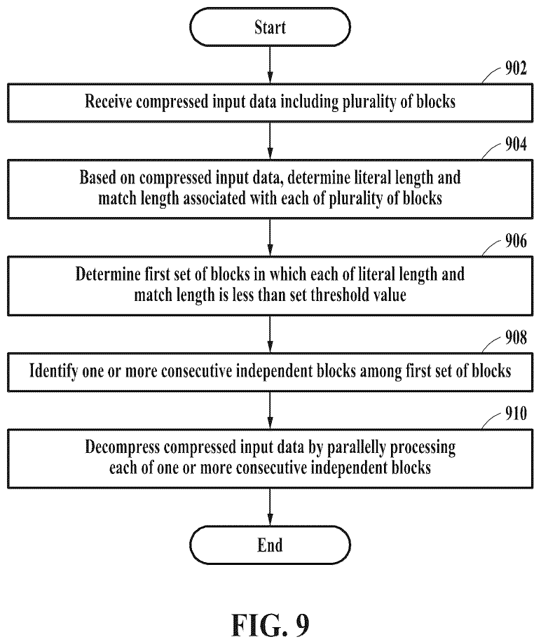

FIG. 9 illustrates an example of an optimized data decompression method 900 using parallel block processing.

Referring to FIG. 9, the decompression method 900 may include operations 902 to 910. The decompression method 900 may be performed by the system 500 and the DM 508 together; details thereof are described with reference to FIGS. 5 to 8B.

In operation 902, the CID 502 may be received. The received CID 502 may include blocks. The blocks may include respective tokens, pieces of literal data, and a match offset. Additionally, the blocks may include a literal length and a match length. The token may have a minimum size of 1 byte. The token may include a first set of bits corresponding to the literal length and a second set of bits corresponding to the match length. The pieces of literal data may be associated with a mismatched string in each of the blocks, and the literal length may indicate the length of the mismatched string. The match offset may indicate an initial point of a matched string associated with each of the blocks in an SHB. The match length may indicate the length of the matched string from the initial point of the matched string. The match offset may have at least 2 bytes.

In operation 904, the literal length and the match length associated with each of the blocks may be determined based on the received CID 502.

In operation 906, the first blocks are determined, the first blocks each having a literal length and a match length that are each less than a threshold.

In operation 908, the CIBs among the first blocks may be identified. Specifically, the position of the matched string 706 associated with each of the first blocks in the SHB 704 may be compared with a position of an output of the previous blocks 708 in the FSB. The decompression method 900 may determine/select the CIBs based on the comparison when the position of the matched string of at least one block among the first blocks does not overlap with the position of the output of the previous blocks.

In operation 910, the received CID 502 may be decompressed by simultaneously processing the CIBs identified using the PDM 802.

The decompression method 900 may obtain DD from the received CID 502 by concatenating the simultaneously processed CIBs. The simultaneously processed and concatenated CIBs in the SHB 704 may be simultaneously updated.

The second blocks (in which at least one of a literal length and a match length is greater than a threshold) may be identified.

Each of the second blocks (identified using the PDM 802) may be sequentially processed according to of the conditions mentioned below.

Each of the second blocks (identified using the PDM 802) may be sequentially processed after simultaneously processing the CIBs (identified using the PDM 802) to decompress the received CID 502.

The decompression method 900 may sequentially process each of the second blocks (identified using the PDM 802) to decompress the received CID 502 and then the identified CIBs may be simultaneously processed using the PDM 802.

The processed second blocks may be simultaneously updated in the SHB 704 using the PDM 802.

To summarize, embodiments and examples described herein may provide several advantages. After determining/identifying the first blocks, the CIBs may be identified among the first blocks.

Then, the CIBs may be processed using the PDM 802 to generate DD. This configuration may provide optimized data decompression using parallel block processing algorithm. In addition, this configuration may overcome an issue related to latency and slow decompression speed that occurs in the prior art.

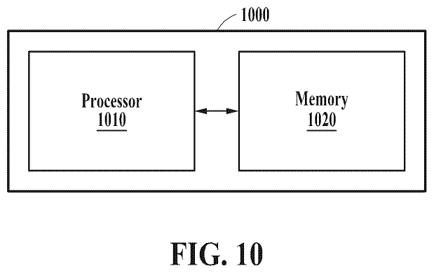

FIG. 10 illustrates an example of a configuration of an electronic device for decompressing data, according to embodiments.

Referring to FIG. 10, an electronic device 1000 may include a processor 1010 and a memory 1020.

The memory 1020 may store an OS for controlling the overall operation of the electronic device 1000, an application program, and storage data. In addition, the memory 1020 may store an application program and instructions or code configured as described herein.

The processor 1010 may control the operations of the electronic device 1000 of FIG. 10 by executing the instructions or code stored in the memory 1020.

The processor 1010 may perform the decompression method 900 of FIG. 9 by executing the instructions stored in the memory 1020.

The processor 1010 may receive CID including blocks by executing the instructions or code stored in the memory 1020, determine a literal length and a match length associated with each of the blocks based on the CID, determine an first blocks in which each of a literal length and a match length is less than a threshold, identify CIBs among the first blocks, and decompress the CID by processing each of the CIBs in parallel.

The computing apparatuses, the processors, the memories, the image sensors, the information output system and hardware, the storage devices, and other apparatuses, devices, units, modules, and components described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, of the hardware components that perform the operations described in this application are implemented by computing hardware, for example, by processors or computers. A processor or computer may be implemented by processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, memories storing the instructions or software that are executed by the processor or computer. Hardware components implemented by a processor or computer may execute the instructions or software, such as an operating system (OS) and software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller, hardware components may be implemented by processors, or a processor and a controller, and other hardware components may be implemented by other processors, or another processor and another controller, processors, or a processor and a controller, may implement a single hardware component, or two or more hardware components. As described above, or in addition to the descriptions above, example hardware components may have any different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes processing element(s) circuits), processors comprising processing circuitry also refers to each processor comprising processing circuitry, as well as some or all of the processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller, operations may be performed by processors, or a processor and a controller, and other operations may be performed by other processors, or another processor and another controller, processors, or a processor and a controller, may perform a single operation, or two or more operations. References to a processor, or processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective processors being configured to perform each of the two or more operations, or any respective combination of processors being configured to perform any respective combination of the two or more operations). Likewise, a reference to a processor-implemented method is a reference to a method that is performed by processors or other processing or computing hardware of a device or system.

The instructions or software to control computing hardware, for example, processors or computers, to implement the hardware components and perform the methods as described above may be written as computer programs, code segments, or other executable instructions or any combination thereof, for individually or collectively instructing or configuring the processors or computers to operate as a machine or special-purpose computer to perform the operations that are performed by the hardware components and the methods as described above. In one example, the instructions or software include machine code that is directly executed by the processors or computers, such as machine code produced by a compiler. In another example, the instructions or software includes higher-level code that is executed by the processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, processors or computers, to implement the hardware components and perform the methods as described above, and any associated data, data files, and data structures, may be recorded, stored, or fixed in or on non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to processors or computers so that the processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of performing data decompression, the method comprising:
receiving compressed input data comprising blocks;
based on the compressed input data, for each of the blocks, determining a corresponding literal length and a corresponding match length;
determining first blocks, each of whose literal length and match length are each less than a threshold;
identifying consecutive independent blocks from among the first blocks; and
decompressing the compressed input data by parallelly processing, with respect to each other, each of the consecutive input blocks.

2. The method of claim 1, wherein the decompressing of the compressed input data comprises:
concatenating the parallelly processed consecutive input blocks; and
updating the concatenated parallelly processed consecutive input blocks in a search history buffer.

3. The method of claim 1, wherein the identifying of the consecutive input blocks among the first blocks comprises:
in a search history buffer, comparing positions of matched strings of the respective first blocks with positions of outputs of each of previous blocks among the first blocks; and
based on a result of the comparison, in response to a position of a matched string of a first block of the first blocks failing to overlap with the position of the output of each of the previous blocks, determining the consecutive input blocks.

4. The method of claim 1, further comprising:
identifying second blocks, each of whose literal length and match length are both greater than or equal to the threshold.

5. The method of claim 4, further comprising:
sequentially processing each of the identified second blocks.

6. The method of claim 5, further comprising:
simultaneously updating the processed second blocks in a search history buffer.

7. The method of claim 5, wherein the sequential processing of each of the identified second blocks is performed after parallelly processing each of the consecutive input blocks.

8. The method of claim 5, wherein the sequential processing of each of the identified second blocks is performed before parallelly processing each of the consecutive input blocks.

9. The method of claim 1, wherein
each of the blocks comprises:
a token having a size of at least 1 byte and comprising a first set of bits corresponding to the block's literal length and a second set of bits corresponding to the block's match length;
pieces of literal data associated with a mismatched string; and
a match offset having a size of at least 2 bytes and indicating an initial point of a matched string associated with each of blocks in a search history buffer, wherein
the literal length indicates a length of a corresponding mismatched string, and
the match length indicates a length of a corresponding matched string from an initial point of the corresponding matched string.

10. A non-transitory computer-readable storage medium storing instructions that, when executed by a processor, cause the processor to perform the method of claim 1.

11. A system for performing data decompression, the system comprising:
a processor comprising processor circuitry,
memory storing instructions or code that when executed by the processor cause the system to:
receive compressed input data comprising blocks;
based on the compressed input data, determine, for each of the blocks, a corresponding literal length and a corresponding match length;
determine first blocks, each of whose literal length and the match length are each less than a threshold;
identify consecutive independent blocks among the first blocks; and
decompress the compressed input data by parallelly processing each of the consecutive input blocks using parallel decompression.

12. The system of claim 11, wherein the parallel decompression decompresses the compressed input data by:
concatenating the parallelly processed consecutive input blocks; and
in a search history buffer, simultaneously updating the concatenated parallelly processed consecutive input blocks.

13. The system of claim 11, wherein the instructions or code further cause the system to, in order to identify the consecutive input blocks among the first blocks:
in a search history buffer, compare positions of matched strings of the respective first blocks with position of outputs of each of previous blocks among the first blocks; and
based on a result of the comparison, in response to a position of a matched string of a first block among the first blocks failing to overlap with the position of the output of each of the previous blocks, determine the consecutive input blocks.

14. The system of claim 11, wherein the instructions or code further cause the system to identify second blocks, each of whose literal length and match length are both greater than or equal to the threshold.

15. The system of claim 14, wherein the instructions or code further cause the system to sequentially process each of the identified second blocks.

16. The system of claim 15, wherein the instructions or code further cause the system to simultaneously update the processed second blocks in a search history buffer.

17. The system of claim 15, wherein the instructions or code further cause the system to sequentially process each of the identified second blocks after parallelly processing each of the consecutive input blocks.

18. The system of claim 15, wherein the instructions or code further cause the system to:
sequentially process each of the identified second blocks before parallelly processing each of the SIB.

19. The system of claim 11, wherein
each of the blocks comprises:
a token having a size of at least 1 byte and comprising a first set of bits corresponding to the literal length and a second set of bits corresponding to the match length;
pieces of literal data associated with a mismatched string; and
a match offset having a size of at least 2 bytes and indicating an initial point of a matched string associated with each of blocks in a search history buffer,
the literal length indicates a length of a corresponding mismatched string, and
the match length indicates a length of a corresponding matched string from an initial point of the corresponding matched string.

20. An electronic device comprising:
a memory storing instructions; and
processors communicatively connected with the memory,
wherein the instructions, when executed by the processors individually or collectively, cause the electronic device to:
receive compressed input data comprising a plurality of blocks;
based on the compressed input data, determine a literal length and a match length associated with each of the plurality of blocks;
determine a first set of blocks first blocks in which each of the literal length and the match length is less than a set threshold value;
identify consecutive independent blocks consecutive input blocks among the first blocks; and
decompress the compressed input data by parallelly processing, with respect to each other, each of the consecutive input blocks.
